(19) United States
(12) Patent Application Publication
(10) Pub. No.: US 2014/0158739 A1
(43) Pub. Date: Jun. 12, 2014

(54) NAILING DEVICE

(71) Applicant: Hilti Aktiengesellschaft, Schaan (LI)

(72) Inventors: Mario GRAZIOLI, Chur (CH); Karl FRANZ, Feldkirch (AT); Karsten RIX, Berneck (CH)

(21) Appl. No.: 13/940,982

(22) Filed: Jul. 12, 2013

(30) Foreign Application Priority Data
Jul. 19, 2012 (DE) 10 2012 212 674.0

(51) Int. Cl. B25C 7/00; B25C 1/00

(52) U.S. Cl. CPC B25C 7/00; B25C 1/00
USPC 227/129; 227/140

(57) ABSTRACT

Nailing device (1), comprising a housing (2), a nail cartridge (5), a setting mechanism for the setting of the nails, a bolt guiding element (6) for placement on the object (16) into which the nails are to be introduced, so that the bolt guiding element (6) is used for the setting of the nails and for the support for the nailing device, a trigger (7) for the activation of the setting mechanism, a supporting foot (8) for the additional support of the nailing device (1); it should be possible to drive the nails into the object (16) without a special alignment of the nailing device (1) by the operator, essentially vertically relative to a hypothetical object plane (17) spanned by the surface of the object (16) into which the nails are driven. This goal is attained in that the supporting foot (8) is provided with two supporting elements (9, 10) for a two-point contact, so that the nailing device (1) together with the bolt guiding element (6) has a three-point contact.

The invention under consideration concerns a nailing device in accordance with the preamble of claim 1.

Nailing devices are particularly used in the construction industry, in order to introduce nails or staples into an object or substrate, for example, made of wood, concrete, or steel. In this way, in a short period of time, it is possible to introduce a larger number of nails or staples into the object or substrate than with a manual pounding of nails, with a hammer, into the object. The nailing devices are thereby generally driven pneumatically, electrically, or with combustion technology. A nail cartridge is used to store a large number of nails or staples.

DE 195 08 437 C2 shows a pneumatically operated nailing device and an electrically operated nailing device is known from DE 89 07 788 U1. DE 31 516 58 A1 describes a gas-operated setting tool.

The nails should be thereby driven—as much as possible, vertically relative to a hypothetical object plane spanned by the surface of the object or substrate—into the object or substrate, with the nailing device. The nailing device is laid on the object to introduce the nails with a bolt guiding element and it is also known that a supporting foot is designed on the nailing device. The supporting foot thereby has only one supporting element, so that together with the bolt guiding element, the nailing device can be set on the object or substrate by means of a two-point contact. In this way, it is possible that, in a disadvantageous manner, the nailing device can tilt laterally during the setting of the nails, so that the nails are set at an incline. Nails set at an incline, however, have the disadvantage that there are considerable failures here or there is a diminished fastening with the set nails.

Therefore, the goal of the invention under consideration is to make available a nailing device, in which the nails can be driven into the object, without a special alignment of the nailing device by the operator, essentially vertically relative to a hypothetical object plane spanned by the surface of the object in which the nails are driven.

This goal is attained with a nailing device comprising a housing, in particular, a nail cartridge, a setting mechanism for the setting of the nails, a bolt guiding element for the placement on the object in which the nails are to be introduced so that the bolt guiding element is used for the setting of the nails and for the supporting for the nailing device, a trigger for the activation of the setting mechanism, a supporting foot for the additional support of the nailing device, wherein the supporting foot is provided with two supporting elements for a two-point contact, so that the nailing device together with the bolt guiding element has a three-point contact.

The supporting foot thereby projects from the housing or perhaps from the nail magazine. With preferred variants, the supporting foot projects from a combustion container holder, such as a gas can compartment, a battery holder, or a handle or a handle extension.

The nailing device is provided with a supporting foot with two supporting elements, so that in this way, the nailing device has a three-point contact. The bolt guiding element forms the first point contact and the two supporting elements on the supporting foot form the two second and third point contacts for the nailing foot. With an object with an essentially plane surface, so that a hypothetical Object plane is spanned by the object or substrate, in which the nails are driven in with the nailing device, therefore, by means of the three-point contact, the bolt guiding element can be aligned essentially vertically relative to the object plane, since as a result of the three-point contact of the nailing device, the longitudinal axis of the bolt guiding element is essentially aligned vertically relative to the hypothetical object plane. The configuration of the two supporting elements is thus designed to the effect that with a placement on a plane surface or the object plane, with a placement of the two supporting elements and the bolt guiding element on the object plane, the longitudinal axis is aligned vertically relative to the object plane.

In particular, the two supporting elements that form the two-point contact on the supporting foot have a spacing of at least 1 cm, 3 cm, 5 cm, or 10 cm relative to one another, and/or the end of the bolt guiding element and the ends of the two supporting elements form the corners of a hypothetical triangle and the sides of the hypothetical triangle have a distance of at least 1 cm, 3 cm, 5 cm or 10 cm and the height of the hypothetical triangle is at least 1 cm, 3 cm, 5 cm, or 10 cm. The two supporting elements require a corresponding distance, an that a sufficient three-point contact of the nailing device is guaranteed—that is, a tilting of the nailing device is essentially prevented in actual practice.

In another development, the two supporting elements have a distance of at least 5 cm, 10 cm, 20 cm, or 30 cm with respect to the bolt guiding element.

Preferably, the bolt guiding element is used to guide the nails or staples in the setting or introduction into the object.

Appropriately, the two supporting elements are separate components, so that the two supporting elements form separate supporting feet—that is, the supporting foot has two parts.

In a supplementary embodiment, the supporting foot is supported on the rest of the nailing device in a manner that allows it to swivel around a swiveling axis, on that in a first swiveling position of the supporting foot, the two supporting elements have a distance with respect to the hypothetical device plane and in a second swiveling position, the two elements are essentially cut from the hypothetical device plane, and a longitudinal axis of the bolt guiding element and swiveling axis lie in the hypothetical device plane. In the first swiveling position, the nailing device thus has a three-point contact and in the second swiveling position, the two point contacts lie on the supporting foot in the hypothetical device plane, so that in this way, the nailing device can tilt or swivel with the lying of the supporting foot and the bolt guiding element on the object or substrate. In certain uses of the nailing device, it may be necessary for there to be a tilting of the nailing device with the lying on the object, for example, in order to introduce nails at an incline into the substrate or in case of a certain hindrance in the operating space of the nailing device.

Preferably, in the first swiveling position, the distance of the two supporting elements to the hypothetical device plane essentially corresponds to the distance of the two supporting elements to the swiveling axis; in particular, the distance of the two supporting elements in the first swiveling position to the hypothetical device plane is at least 0.5 cm, 1.5 cm, 2.5 cm, or 5 cm, and/or the first and second swiveling positions are essentially swiveled, by 90° relative to one another around the swiveling axis. The first and second swiveling positions are essentially swiveled by 90° relative to one another—that is, are swiveled relative to one another, with a deviation of less than 10°, 5°, 3°, or 2°, for 90° or a right angle. In the first swiveling position, the distance of the two supporting elements or the ends of the supporting elements to the hypothetical plane essentially corresponds to the distance of the two supporting elements or the ends of the supporting elements to the swiveling axis—that is, with a deviation of less than 2 cm, 1 cm, 0.5 cm, or 0.2 cm.

Preferably, the two supporting elements have the same distance to the swiveling axis. In an alternative embodiment, the two supporting elements have different distances to the swiveling axis.

In one variant, the swiveling axis is aligned essentially parallel to the longitudinal axis of the bolt guiding element or is aligned at an acute angle, in particular, between 3° and 45°, preferably between 5° and 30°, for example, between 7° and 20°, relative to the longitudinal axis of the bolt guiding element, and/or the swiveling axis lies in the hypothetical device plane. The swiveling axis is aligned essentially parallel to the longitudinal axis of the bolt guiding element—that is, aligned with a deviation of less than 5°, 3°, 2′, or 1° relative to the longitudinal axis of the bolt guiding element.

Appropriately, the supporting foot is fastened to and supported on the rest of the nailing device with a swiveling mechanism and can be affixed and detached with the swiveling mechanism in the first and second swiveling positions; in particular, it can be locked and unlocked, in particular, by means of a movement of the supporting foot parallel to the swiveling axis. With the application of a force or movement on the supporting foot essentially parallel to the swiveling axis of the supporting foot, it can be fastened and loosened on the rest of the nailing device in the two swiveling positions—that is, it can, in particular, he locked and unlocked. In this way, a particularly simple affixing of the supporting foot in the two swiveling positions is guaranteed.

In an additional embodiment, the supporting foot can be removed from the rest of the nailing device. With a removed supporting foot, the nailing device has only a one-point contact—that is, only the bolt guiding element is used for the contact on the substrate. In this way, the nails can be introduced into the object or substrate at any angle to the hypothetical object plane.

Preferably, the supporting foot is affixed in a detachable manner on the rest of the nailing device and by completely loosening from the rest of the nailing device, can be brought from a first to a second swiveling position.

In another embodiment, the supporting foot is fastened on the rest of the nailing device with an overload mechanism, so that with an application of a force on the supporting foot that exceeds an overload force, the supporting foot can be automatically detached from the rest of the nailing device; in particular, the overload mechanism is firmed by the swiveling mechanism. In actual practice for the nailing device, it can also fall, for example, and the supporting foot thereby hits the object. The overload mechanism guarantees that with an exceeding of an overload force with the overload mechanism, the connection between the supporting foot and the rest of the nailing device is independently and automatically loosened, so that in this way, the danger of damage to the supporting foot or to the device is reduced.

In particular, the two supporting elements, in particular, in the end area of the supporting elements, are made of rubber at least in part and in particular, completely. The placement areas of the supporting elements made of rubber guarantee a particularly secure stop of the nailing device, in particular, with respect to sliding on the surface of the object.

In another development, the setting mechanism can be operated electrically, pneumatically, or with combustion technology, wherein the fuel is, in particular, solid, liquid, or gaseous, and/or the setting mechanism and the supporting foot are connected with one another via a nail cartridge.

Appropriately, the nailing device comprises a battery with an electrically operated setting mechanism.

Preferably, with a pneumatically operating setting mechanism, the nailing device comprises a pneumatic interface to connect a compressed air hose.

Preferably, with a setting mechanism operated with combustion technology, the nailing device comprises a fuel cartridge, in particular, in the form of a cartridge strip or a gas can.

In an additional embodiment, the housing of nailing device is made at least in part, in particular, completely, of metal and/or plastic.

In an additional embodiment, the nailing device has a separate actuation element as a supplement to the trigger, to deactivate the setting mechanism. With an activated setting mechanism, the nails are driven into the object by the nailing device and with a deactivated setting mechanism, the setting mechanism is not in service—that is, nails are not driven into the object by the nailing device.

Appropriately, the nailing device is also regarded as a stapler—that is, staples or other setting elements can be introduced into the object with the nailing device.

In another embodiment, the end of only one supporting element lies in the second swiveling position of the supporting foot and the end of the bolt guiding element lies in a hypothetical object plane, since there is an acute angle between the swiveling axis of the supporting foot and the longitudinal axis of the bolt guiding element.

In the following, embodiment examples of the invention are described in more detail with reference to the appended drawings. The figures show the following:

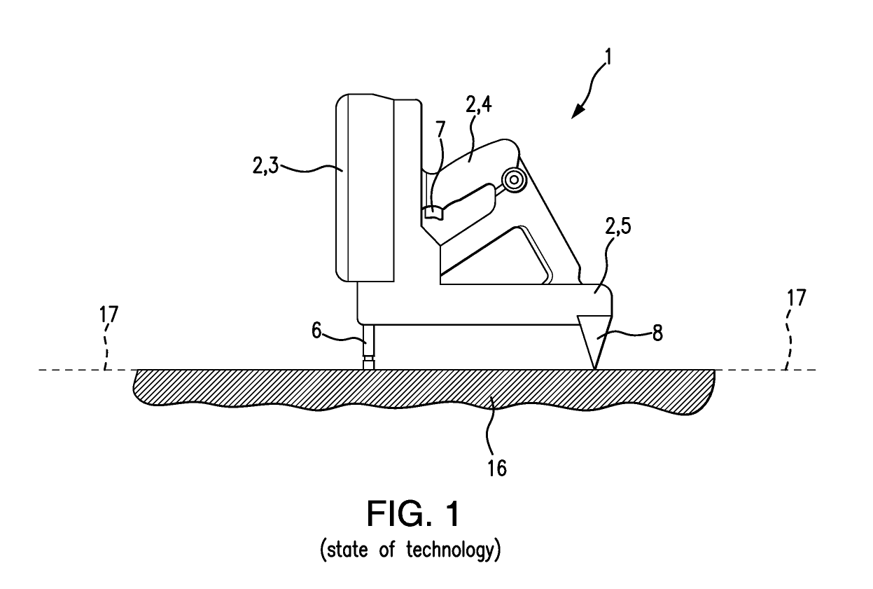

FIG. 1, a side view of a nailing device known from the state of the art;

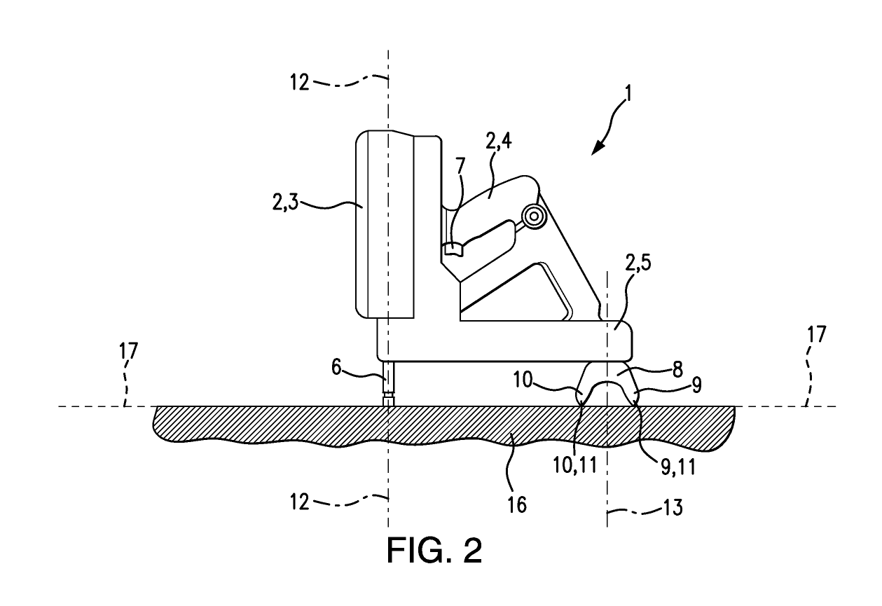

FIG. 2, a side view of a nailing device in accordance with the invention in a first embodiment example;

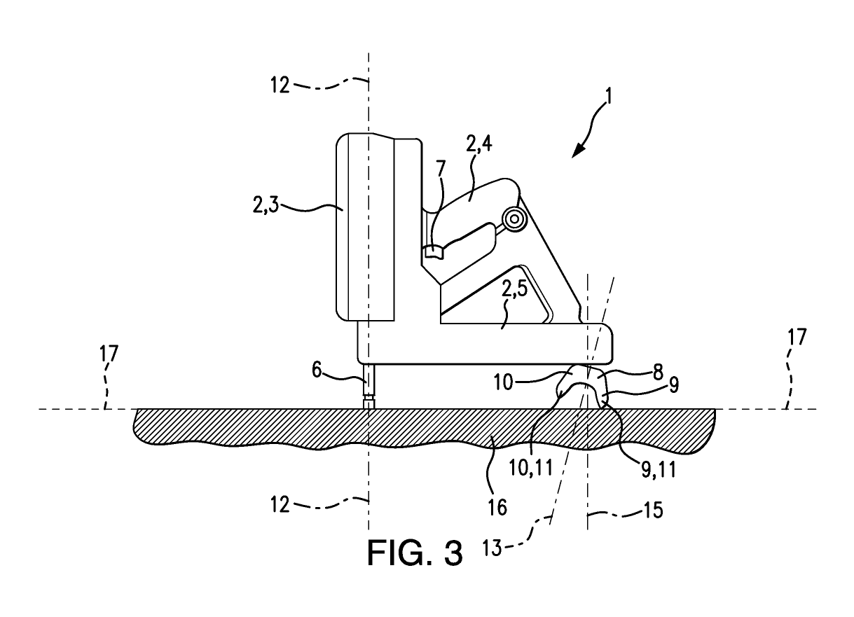

FIG. 3, a side view of a nailing device in accordance with the invention in a second embodiment example;

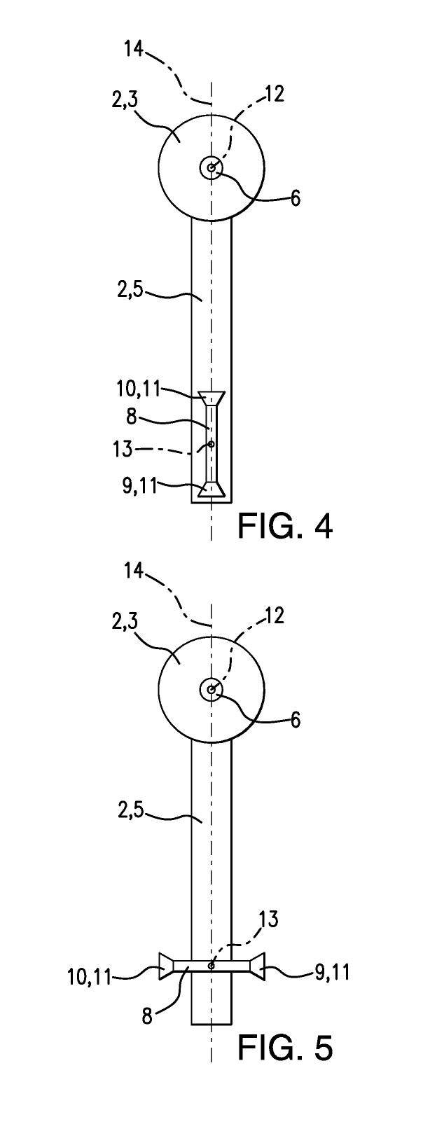

FIG. 4, a bottom view of the nailing device in accordance with FIG. 2 with a supporting foot in a second swiveling position; and

FIG. 5, a bottom view of the nailing device in accordance with FIG. 2 with the supporting foot in a first swiveling position.

Nailing devices it are used to drive nondepicted nails into an object 16 or substrate 16, for example, made of wood, concrete, or steel. To this end, the nailing device 1 has a housing 2 made of metal and/or plastic, which generally consists of several parts. Within a device body 3 enclosed by the housing 2, there is a nondepicted setting mechanism, which is operated electrically, pneumatically, or with combustion technology. A nail cartridge 5 is enclosed by another part of the housing 2. The nail cartridge 5 comprises a large number of nails and for the setting of the nails, the nails are conveyed from the nail cartridge 5 to the setting mechanism and by means of the setting mechanism through a bolt guiding element 6 as a component of the setting mechanism, are driven into the object 16 electrically or pneumatically. The bolt guiding element 6 thereby has a longitudinal axis 12, and the setting mechanism can be activated with a trigger 7. To hold the nailing device 1, the housing 2 is designed to the effect that it also forms a handle 4 for the holding of the nailing device 1.

FIG. 1 shows a nailing device 1 known from the state of the art. The nails are driven through the bolt guiding element 6 in the direction of the longitudinal axis 12 of the bolt guiding element 6 into the substrate or object 16. The nails should thereby be driven as vertical as possible relative to hypothetical object plane 17 spanned by the object 16 or the surface of the object 16. To this end, the nailing device 1 has a supporting foot 8 and the supporting foot 8 thereby has only one supporting element in the representation in FIG. 1 from the state of the art, so that, in this way, the nailing device 1 from the state of the art has only a two-point contact. The nailing device 1 can thus swivel around a tilting axis, which corresponds to the object plane 17 shown with a dotted line as a result of the intersection in FIG. 1, since the object plane 17 cut 1 vertically, relative to the drawing plane of FIG. 1 as a result of the intersection in FIG. 1. In this way, with a tilting of the nailing device 1, the nails are driven into the object 16 at an incline to the hypothetical object plane 17—for example, at an acute angle. This is connected with disadvantages, for example, due to setting failures or a diminished fastening of the nails.

FIGS. 2 to 5 show two embodiment examples of a nailing device 1 in accordance with the invention. FIG. 2 thereby shows a first embodiment example of the nailing device 1 in accordance with the invention. The supporting foot 8 has a first supporting element 9 and a second supporting element 10. The end areas 11 of the two supporting elements 9, 10 thus form a second and a third point as point contacts for the nailing device 1, so that together with the point contact on the bolt guiding element 6, the nailing device 1 in accordance with the invention has a three-point contact.

The supporting foot 8 can swivel around a swiveling axis 13 and the swiveling axis 13 is aligned parallel to the longitudinal axis 12 of the bolt guiding element 6. FIG. 4 shows a second swiveling position and FIG. 5, a first swiveling position of the supporting foot 8. In the swiveling position in FIG. 5, there is a distance of approximately 3 cm between the two end areas 11 and a hypothetical device plane 14 and as a result of the construction or geometric design of the supporting foot 8, there is also a distance between the supporting foot 8 and the swiveling axis 13. The hypothetical device plane 14 is in the longitudinal axis 12 and in the swiveling axis 13. In this first swiveling position of the supporting foot 8 shown in FIG. 5, the nailing device 1—as a result of the three-point contact—can no longer be tilted when the nails are introduced, so that in this way, an essentially vertical introduction of the nails relative to the hypothetical object plane 17 is guaranteed. in the second swiveling axis shown in FIG. 4, the supporting foot 8 essentially swivels 90° around the swiveling axis 13 with respect to the first swiveling position in accordance with FIG. 5. In this swiveling position shown in FIG. 4, the two end areas 11 of the supporting element 9, 10 intersect the hypothetical device plane 14 or there is only a very short distance of, for example, less than 1 cm to the hypothetical device plane 14. In this swiveling position of the supporting foot 8, therefore, as in the state of the art, the nailing device can be tilted when it is placed on the object 16. With certain applications with the nailing device 1, for example, for the controlled inclined introduction of nails or when working in a constricted work space, for example, in a corner area, this may be required or desired in exceptional cases.

FIG. 3 shows a second embodiment example of the nailing device 1 in accordance with the invention. Below, essentially only the differences with the first embodiment example of the nailing device it in accordance with the invention in FIG. 2 are described. The swiveling axis 13 is aligned at an acute angle of approximately 10° with the longitudinal axis 13 and lies in the hypothetical device plane 14. An auxiliary longitudinal axis 15 is thereby shifted parallel and thus corresponds in its alignment to the longitudinal axis 12. The auxiliary longitudinal axis 15 is thus a longitudinal axis 12 shifted parallel. Therefore, only the first supporting element 9 lies on the object 16 in the swiveling position of the supporting foot 8 shown in FIG. 3, and the second supporting element 10 does not have any contact with the object 16. With a swiveling of the supporting foot 8 into the first swiveling position, however, the two supporting elements 9, 10, again and the bolt guiding element 6 lie on the object 116, so that in an analogous manner as in the first embodiment of the nailing device according to FIG. 2 and in accordance with the invention, a three-point contact is again guaranteed with the nailing device 1.

Considered as a whole, substantial advantages are connected with the nailing device 1 in accordance with the invention. The nailing device 1 has a three-point contact, so that in this way, a precise setting of the nails vertical to the hypothetical object plane 17 is possible. In order to guarantee in certain applications of the nailing device 1 a tilting of the nailing device 1 also, as with a two-point contact, the nailing gun 1 can also be tilted when used to set the nails as a result of the second swiveling position of the supporting foot 8. Furthermore, the supporting foot 8 can also be removed from the rest of the nailing device 1—that is, from the nail cartridge 5 in the embodiment example in accordance with FIGS. 2 and 3, since a corresponding, nondepicted swiveling and/or fastening mechanism is correspondingly designed for the supporting foot 8. Without the supporting foot 8, the nails I can be driven in a random acute angle with respect to the hypothetical object plane 17 into the object 16. With certain applications of the nailing device 1, this is also required and desired.

1. A nailing device, comprising
a housing,
a setting mechanism for setting nails,
a bolt guiding element for placement on an object in which the nails are to be introduced, so that the bolt guiding element is used for setting the nails and for support for the nailing device,
a trigger for activating the setting mechanism,
a supporting foot for additional support of the nailing device,
wherein the supporting foot is provided with two supporting elements for a two-point contact, so that the nailing device together with the bolt guiding element has a three-point contact.

2. The nailing device according to claim 1, wherein
the two supporting elements, which form the two-point contact on the supporting foot, have a spacing of at least 1 cm, 3 cm, 5 cm, or 10 cm with respect to one another,
and/or
the end of the bolt guiding element and the ends of the two supporting elements form the corners of a hypothetical triangle having sides, and the sides of the hypothetical triangle form a distance of at least 1 cm, 3 cm, 5 cm, or 10 cm, and the height of the hypothetical triangle is at least 1 cm, 3 cm, 5 cm, or 10 cm.

3. The nailing device according to claim 1, wherein
the two supporting elements have a distance of at least 5 cm, 10 cm, 20 cm, or 30 cm to the bolt guiding element.

4. The nailing device according to claim 1, wherein
the supporting foot can be swiveled around a swiveling axis on which the nailing device is supported, so that in a first swiveling position of the supporting foot, the two supporting elements have a distance to a hypothetical device plane, and in a second swiveling position, the two supporting elements are essentially cut from the hypothetical device plane and a longitudinal axis of the bolt guiding element and the swiveling axis lie in the hypothetical device plane.

5. The nailing device according to claim 4,
wherein, in the first swiveling position, the distance of the two supporting elements to the hypothetical device plane essentially corresponds to the distance of the two supporting elements to the swiveling axis
and/or
the first and second swiveling positions are essentially swiveled, by 90° relative to one another around the swiveling axis.

6. The nailing device according to claim 4, wherein
the swiveling axis is aligned parallel to the longitudinal axis of the bolt guiding element or is aligned at an acute angle, relative to the longitudinal axis of the bolt guiding element
and/or
the swiveling axis lies in the hypothetical device plane.

7. The nailing device according to claim 4, wherein
the supporting foot is fastened and supported with a swiveling mechanism on the nailing device and can be affixed to the device and detached from the device with the swiveling mechanism in the first and second swiveling positions.

8. The nailing device according to claim 1, wherein
the supporting foot is affixed in a detachable manner on the nailing device and the support foot can be loosened and brought from a first to a second swiveling position.

9. The nailing device according to claim 1, wherein
the supporting foot is fastened on the nailing device with an overloading mechanism, so that when a force that exceeds an overload force is applied on the supporting foot, the supporting foot can automatically be detached from the nailing device.

10. The nailing device according to claim 1, wherein
the two supporting elements are made at least in part, of rubber.

11. The nailing device according to claim 1, wherein
the setting mechanism can be operated electrically, pneumatically, or with combustion technology,
and/or
the setting mechanism and the supporting foot are connected with one another via a nailing cartridge.

12. The nailing device according to claim 2, wherein the supporting foot can be swiveled around a swiveling axis on which the nailing device is supported, so that in a first swiveling position of the supporting foot, the two supporting elements have a distance to a hypothetical device plane, and in a second swiveling position, the two supporting elements are essentially cut from the hypothetical device plane and a longitudinal axis of the bolt guiding element and the swiveling axis lie in the hypothetical device plane.

13. The nailing device according to claim 3, wherein the supporting foot can be swiveled around a swiveling axis on which the nailing device is supported, so that in a first swiveling position of the supporting foot, the two supporting elements have a distance to a hypothetical device plane, and in a second swiveling position, the two supporting elements are essentially cut from the hypothetical device plane and a longitudinal axis of the bolt guiding element and the swiveling axis lie in the hypothetical device plane.

14. The nailing device according to claim 5, wherein, in the first swiveling position, the distance of the two supporting elements in the first swiveling position to the hypothetical device plane is at least 0.5 cm, 1.5 cm, 2.5 cm, or 5 cm,
and/or
the first and second swiveling positions are essentially swiveled, by 90° relative to one another around the swiveling axis.

15. The nailing device according to claim 6, wherein the swiveling axis is aligned at an acute angle of smaller than 45° relative to the longitudinal axis of the bolt guiding element
and/or
the swiveling axis lies in the hypothetical device plane.

16. The nailing device according to claim 15, wherein the swiveling axis is aligned at an acute angle of between 1° and 30° relative to the longitudinal axis of the bolt guiding element
and/or
the swiveling axis lies in the hypothetical device plane.

17. The nailing device according to claim 16, wherein the swiveling axis is aligned at an acute angle of between between 7° and 20° relative to the longitudinal axis of the bolt guiding element
and/or
the swiveling axis lies in the hypothetical device plane.

18. The nailing device according to claim 7, wherein the supporting foot can be locked and unlocked with the swiveling mechanism in the first and second swiveling positions.

19. The nailing device according to claim 8, wherein the supporting foot in the first and second swiveling positions can be locked and unlocked.

20. The nailing device according to claim 10, wherein the two supporting elements have end areas that are made at least in part, of rubber.
